(19) United States
(12) Patent Application Publication
(10) Pub. No.: US 2009/0254938 A1
(43) Pub. Date: Oct. 8, 2009

(54) DIRECT MARKETING ON TELEVISION OVER INTERNET

(76) Inventor: Peter Mortensen, Tustin, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/099,660

(22) Filed: Apr. 8, 2008

(51) Int. Cl. H04N 7/10

(52) U.S. Cl. 725/32

(57) ABSTRACT

Systems and methods for effectively and non-intrusively directly marketing a manufacturer's consumer electronic products on the screen of a television over a TCP/IP or other communication link. In a television that preferably includes a screen, an OSD controller, a video display system coupled to the screen and OSD controller, a CPU coupled to the OSD controller, and a modem or other means coupled to the CPU and used to communicate with a manufacturer's server over the internet or other network. The CPU preferably includes non-volatile memory and software stored in the memory. The software includes a menu system that includes a direct marketing menu item; selection of which by the user enables the download of marketing content over the internet and display on the television. The software further includes a set of instructions for accessing upon system power on or after a predetermined period of time of television operation a manufacturer's server to check for updated marketing content and display of an icon indicating the availability of marketing content.

### FIELD

The present invention relates generally to televisions and, more particularly, to systems and methods that facilitate direct marketing over the internet and displayed on the television.

### BACKGROUND

Television and other consumer electronics sales continue to become more and more competitive as the capabilities and the features of such products continue to expand and improve. Manufacturers continue to look for more effective marketing techniques to expand the exposure of their products to a greater number of consumers and improve sales. Some companies are spending fortunes on direct marketing and direct customer communication campaigns. The techniques typically used in such direct marketing campaigns can be intrusive and may in some instance have a negative effect on sales.

Therefore, it would be desirable to provide systems and methods that facilitate an effective means to directly market a manufacturers products and upgrades in a non-intrusive manner.

### SUMMARY

Embodiments described herein are directed to improved methods and systems for effectively and non-intrusively directly marketing a manufacturer's consumer electronic products on the screen of a manufacturer's television over a TCP/IP or other communication link. In one embodiment, a television includes a screen, an on-screen-display controller, a projection or video display system coupled to the screen and the on-screen display (OSD) controller, a central processing unit (CPU) coupled to the OSD controller, and a modem or other means coupled to the CPU and used to communicate with a manufacturer's server over the internet or other network. The CPU preferably includes non-volatile memory and software stored in the memory. The software includes a menu system that includes a direct marketing menu item such as, e.g., Mitsubishi News; selection of which by the user enables the download of marketing content over the internet and display on the television. Alternatively, selection of the direct marketing menu item causes the display of a sub-menu with several categories of marketing content that could be downloaded and displayed.

In another embodiment, the software includes a series of instructions to automatically access the manufacturer's server upon power up of the television or after a predetermined period of time of television operation to check for any news or updates since the previous time the television accessed the server, and, if news or updates are available, causing the OSD to display an icon on the screen indicating to the user the availability of news and updates. Selection of the icon by the user similarly enables the download and display of news or updates available from the manufacturer. Alternatively, the selection of the icon by the user will cause the display of the direct marketing sub-menu discussed above.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television system coupled to a manufacturer's server over the internet.

FIG. 2 is a process diagram of a menu system for accessing marketing material.

FIG. 3 is a process diagram depicting a method for automatically accessing a manufacture's server to check for news and other marketing content updates.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Embodiments described herein are directed to improved methods and systems for effectively and non-intrusively directly marketing a manufacturer's consumer electronic products on a screen of a television of the manufacturer over a TCP/IP or other communication link. The marketing content is preferably accessed voluntarily by a user through the television's menu based control system. In an alternative embodiment, an icon indicating the availability of marketing content is displayed on a screen of the television within a graphical user interface. If the icon is selected by the user, marketing content is downloaded and displayed on the screen of the television.

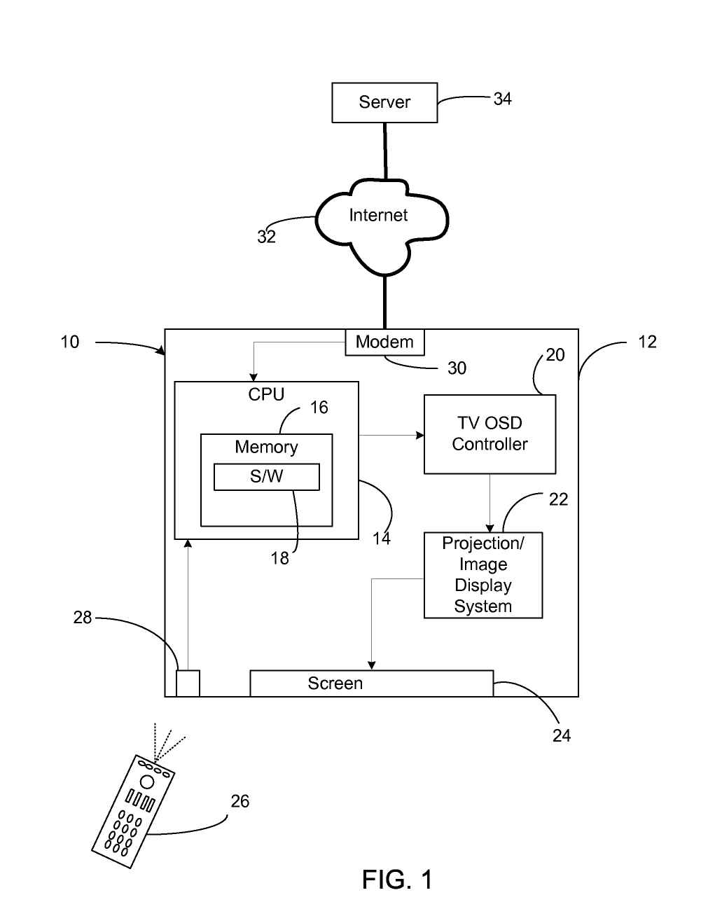

Turning to the figures, the embodiments provided herein are described in detail. A typical television 10, as depicted in FIG. 1, includes an enclosure 12 and a screen 24 housed in or coupled to the enclosure 12. Housed within the enclosure 12 is a central processing unit (CPU) 14 including non-volatile memory 16 with system software 18 stored therein. The software 18 preferably comprises a set of instructions to enable the setup and operation of the television system 10 and download and display of marketing content. Also housed within the enclosure 12 is a projection or image display system 22 coupled to the screen 24 and an on screen display (OSD) controller 20 coupled to the CPU 14 and the image display system 22. The OSD controller 20 controls what is displayed on the screen 24.

The television system 10 preferably further includes a remote control device 26 wirelessly coupled to the television 10 to operate and control the television. The remote control device 26 can send infra red (IR) signals, radio frequency (RF) signals or like that are received by a receiver 28 housed in the front of the enclosure 12 and coupled to the CPU 14. The television system 10 can also be controlled through the use of buttons positioned on a control panel (not shown) located on the front or adjacent the front of the enclosure 12 and coupled to the CPU 14.

The television system 10 preferably includes a modem 30 or other means coupled to the CPU 14 and used to communicatively couple to a manufacturer's server 34 across the internet 32 or other network. Although depicted as internal to the television system 10, the modem 30 can alternatively be located external to the television system 10 and coupled to the CPU 14 through a communications port.

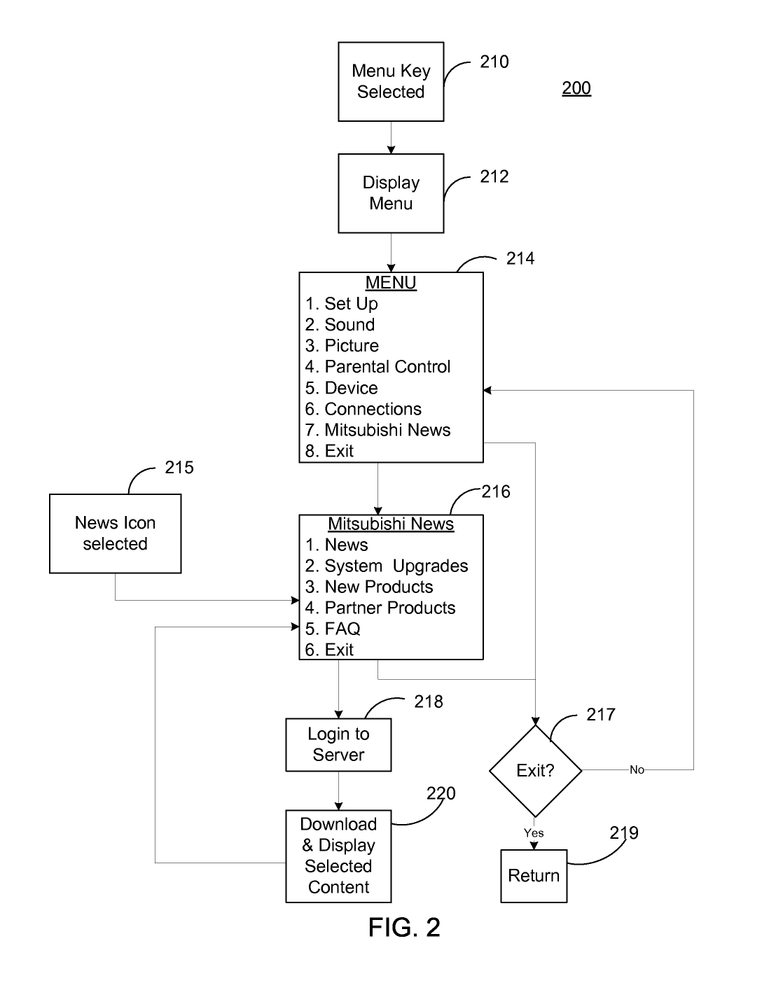

As depicted in FIG. 2, the software 18 includes a menu system that includes a direct marketing menu item such as, e.g., Mitsubishi News; selection of which by the user enables the download of marketing content over the internet 32 from the manufacturer's server 34 and display on the screen 24 of the television 10. Alternatively, selection of the direct marketing menu item causes the display of a sub-menu with several categories of marketing content that could be downloaded and displayed.

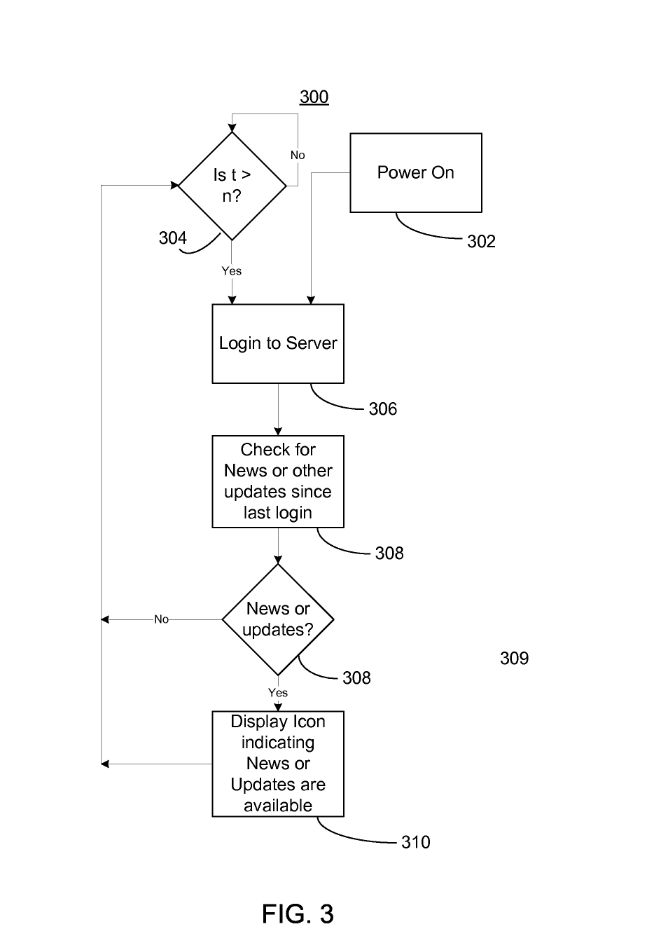

In another embodiment, the software 18, as depicted in FIG. 3, includes a series of instructions to automatically access the manufacturer's server 34 upon power up of the television and/or after a predetermined period of time to check for any news or updates since the previous time the television accessed the server, and, if news or updates are available, causing the OSD controller to display an icon on the screen indicating to the user the availability of news and updates. Selection of the icon by the user similarly enables the download and display of news or updates available from the manufacturer. Alternatively, the selection of the icon by the user will cause the display of the direct marketing sub-menu discussed above.

In operation, as depicted in FIG. 2, a menu based process 200 can be followed to access and display a manufacturer's marketing content on the screen of the television. When the user, at step 210, selects the menu key on the front panel of the television 10 or on the remote control 26, the OSD controller 20 is caused to display, at step 212, a menu on the screen 24 of the television 10. If at step 214, the user selects a menu item corresponding to a manufacturer's marketing content, which is depicted here as menu item number 7 “Mitsubishi News”, the system logs into the manufacture server as depicted at step 218 and then downloads and displays the manufacturer's marketing content as depicted at step 220. In the alternative, a submenu is caused to be displayed that includes selection options relating to different types of manufacturer marketing content, e.g., “news”, “system upgrades”, “new products”, “partner products”, “frequently asked questions” or the like. Depending on the selection made at step 216, the system will log into the manufacture server as depicted at step 218 and then download and display the selected manufacturer's marketing content as depicted at step 220.

In the alternative, as depicted at step 215, if an icon displayed on the screen of the television to indicate the availability of manufacturer's news is selected, the system logs into the manufacture server as depicted at step 218 and then downloads and displays the manufacturer's marketing content as depicted at step 220. In the alternative, a submenu is caused to be displayed that includes selection options relating to different types of manufacturer marketing content, e.g., “news”, “system upgrades”, “new products”, “partner products”, “frequently asked questions” or the like. Depending on the selection made at step 216, the system will log into the manufacture server as depicted at step 218 and then download and display the selected manufacturer's marketing content as depicted at step 220.

Turning to FIG. 3, a process 300 for automatically accessing a manufacturer's server in search of new or updated marketing content is depicted. Upon power on at step 302 or after a predetermined period of time of television operation, i.e., where t>n, the system logs into the manufacturer's server at step 306 and checks at step 308 for content that has been updated since the last time the system logged into the server. If no updates are available, the process returns to step 304. If there is updated content, an icon indicating the existence of updated content is caused to be displayed at step 310. The updated content is accessed and caused to be displayed by selecting the icon as indicated above. Alternatively, the updated content can be downloaded and stored in memory on the system. When the icon is selected, instead of logging back into the manufacturer's server, the system accesses the content stored in memory and displays the content on the screen.

The particular examples set forth herein are instructional and should not be interpreted as limitations on the applications to which those of ordinary skill are able to apply the systems and methods described herein. Modifications and other uses are available to those skilled in the art which are encompassed within the spirit of the invention as defined by the scope of the appended claims.

What is claimed is:

1. A television comprising
a screen,
an on-screen-display (OSD) controller,
a display system coupled to the screen and the OSD controller,
a central processing unit (CPU) coupled to the OSD controller, and
a means to communicate with a manufacturer of the television's server over the internet or other network, wherein the CPU includes non-volatile memory and software stored in the memory, the software comprises a series of instructions for displaying a menu system that includes a direct marketing menu item and, in response to a user's selection of the marketing menu item, a series of instructions for accessing the manufacture's marketing content over the internet.

2. The television of claim 1, wherein the software further comprise a series of instruction for displaying a sub-menu in response to a user's selection of the marketing menu item, wherein the sub-menu comprises a plurality of selection options corresponding to different categories of marketing content that could be accessed.

3. The television of claim 1, wherein the software includes a series of instructions to automatically access the manufacturer's server upon power up of the television to check for news or updates since the previous time the television accessed the server.

4. The television of claim 3, wherein the software includes a series of instructions to cause the OSD to display an icon on the screen indicating to the user the availability of news and updates.

5. The television of claim 1, wherein the software includes a series of instructions to automatically access the manufacturer's server after a predetermined period of time of television operation to check for news or updates since the previous time the television accessed the server.

6. The television of claim 5, wherein the software includes a series of instructions to cause the OSD to display an icon on the screen indicating to the user the availability of news and updates.

7. The television of claim 6, wherein the software includes a series of instructions to access news or updates available from the manufacturer in response to a user's selection of the menu icon.

8. The television of claim 7 wherein the software includes a series of instructions causing the display of a marketing sub-menu in response to a user selection of the menu icon, wherein the sub-menu comprise a plurality of selection options corresponding to different categories of marketing content that is available for accessing.

9. The television of claim 4, wherein the software includes a series of instructions to access news or updates available from the manufacturer in response to a user's selection of the menu icon.

10. The television of claim 9 wherein the software includes a series of instructions causing the display of a marketing sub-menu in response to a user selection of the menu icon, wherein the sub-menu comprise a plurality of selection options corresponding to different categories of marketing content that is available for accessing.
